(19) United States
(12) Patent Application Publication
(10) Pub. No.: US 2009/0084257 A1
(43) Pub. Date: Apr. 2, 2009

(54) Hydraulic cylinder having multi-stage snubbing valve

(75) Inventors: Christopher Paul Buckley, Bakewell (GB); Dinesh P. Desai, Aurora, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/905,350

(22) Filed: Sep. 28, 2007

(51) Int. Cl. F15B 13/042

(52) U.S. Cl. 91/403; 37/442; 414/408

(57) ABSTRACT

A hydraulic cylinder for use with a machine is disclosed. The hydraulic cylinder including a tube having a first end and a second end and a cap assembly connected to the first end of the tube to close off the first end. The hydraulic cylinder also includes a piston assembly having a piston rod and being movably disposed within the tube to move between the first end and the second end. The hydraulic cylinder further includes a valve plunger connected to the cap assembly and having a first axial bore and a plurality of radially oriented passages. The plurality of radially oriented passages being configured to sequentially restrict fluid flow through the first axial bore as the piston assembly approaches the first end of the tube.

### TECHNICAL FIELD

The present disclosure relates generally to a hydraulic cylinder, and more particularly, to a hydraulic cylinder having a multi-stage snubbing valve.

### BACKGROUND

Machines such as, for example, dozers, loaders, excavators, motor graders, and other types of machinery use hydraulic cylinders to accomplish a variety of tasks. Problems can be encountered in the operation of a hydraulic cylinder if a piston within the cylinder impacts against an end structure of the cylinder. Such impacts can disturb work operations, cause undesirable noise, and can cause damage to the cylinder or other components. To prevent such problems, a snubbing device may be used to cushion the end of a piston stroke within the cylinder. The snubbing device may be configured to increasingly restrict a fluid passage as the piston nears an end structure, thereby slowing and cushioning the end of the piston stroke. In some systems, the snubbing device may be used together with a sensor.

One example of a hydraulic cylinder using a snubbing device and a sensor is disclosed in U.S. Pat. No. 7,121,185 (the '185 patent) issued to Alrefai on Oct. 17, 2006. The '185 patent describes a hydraulic cylinder having a tube with a first end and a second end. The hydraulic cylinder also has a piston assembly movably disposed within the tube and configured to move between the first and second ends of the tube. The hydraulic cylinder further has a valve plunger connected to the piston assembly and having an axial bore. The hydraulic cylinder additionally has a cap assembly connected to the tube to close off the first end of the tube. The cap assembly has a fluid passageway, and the valve plunger is configured to progressively restrict fluid flow through the fluid passageway as the piston assembly approaches the first end of the tube. The cap assembly also includes a sensor disposed within the cap bore and configured to determine a position of the piston assembly and/or control a position-based electronically-controlled hydraulic valve system.

As the hydraulic cylinder of the '185 patent is operated, the sensor determines the position of the piston assembly relative to the tube. As the piston nears the end of the hydraulic cylinder's stroke, a tapered portion of the valve plunger enters the fluid passageway of the cap assembly, gradually reducing the area available for fluid flow out of the tube at a substantially constant rate. This reduction in available flow area creates a buildup in pressure between the piston assembly and the cap assembly that gradually slows and eventually stops movement of the piston assembly relative to the cap assembly, before the piston assembly impacts the cap assembly.

Although the valve plunger of the '185 patent may help prevent impact between the piston assembly and the cap assembly, The valve plunger may move out of alignment with the cap assembly during operation, making the hydraulic cylinder prone to additional modes of failure. Any misalignment in the piston assembly may greatly affect the snubbing action of the valve plunger. Additionally, the constant rate snubbing action of the '185 patent may not be suitable for all applications of the hydraulic cylinder.

The disclosed hydraulic cylinder is directed to overcoming one or more of the problems set forth above.

### SUMMARY OF THE INVENTION

In one aspect, the present disclosure is directed to a hydraulic cylinder. The hydraulic cylinder may include tube having a first end and a second end and a cap assembly connected to the first end of the tube to close off the first end of the tube. The hydraulic cylinder may also include a piston assembly having a piston rod and being movably disposed within the tube to move between the first end and the second end. The hydraulic cylinder may further include a valve plunger connected to the cap assembly and having a first axial bore and a plurality of radially oriented passages. The plurality of radially oriented passages may be configured to sequentially restrict fluid flow through the first axial bore as the piston assembly approaches the first end of the tube.

In another aspect, the present disclosure is directed to a method of operating a hydraulic cylinder. The method may include filling and draining fluid from both a first end and second end of the hydraulic cylinder. The method may also include creating a force differential within the hydraulic cylinder to expand and retract the hydraulic cylinder. The method may further include restricting a flow of fluid at a plurality of locations in a discrete multi-stage manner, wherein the plurality of locations always remains at the first end of the hydraulic cylinder.

### BRIEF DESCRIPTION OF THE DRAWINGS

FIG. 1 is a diagrammatic illustration of an exemplary disclosed machine;

FIG. 2 is a perspective view of an exemplary disclosed hydraulic cylinder that may be used with the machine of FIG. 1; and

FIG. 3 is a cross-sectional illustration of the hydraulic cylinder of FIG. 2.

### DETAILED DESCRIPTION

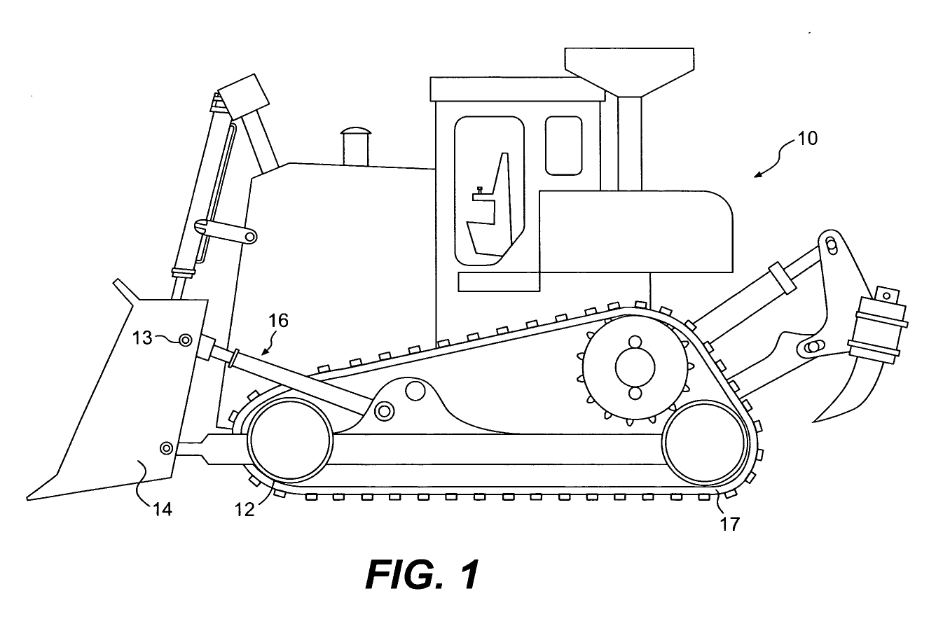

FIG. 1 illustrates an exemplary machine 10. Machine 10 may be a fixed or mobile machine that performs some type of operation associated with an industry such as mining, construction, farming, or any other industry known in the art. For example, machine 10 may be an earth moving machine such as a dozer, a loader, a backhoe, an excavator, a motor grader, a dump truck, or any other earth moving machine. Machine 10 may include a frame 12, at least one implement 14, and at least one hydraulic cylinder 16 connecting implement 14 to frame 12.

Frame 12 may include any structural unit that supports movement of machine 10. Frame 12 may be, for example, a stationary base frame connecting a power source (not shown) to a traction device 17, a movable frame member of a linkage system, or any other frame known in the art. Implement 14 may include any device used in the performance of a task. For example, implement 14 may include a blade, a bucket, a shovel, a ripper, a dump bed, a propelling device, or any other task-performing device known in the art. Implement 14 may be connected to frame 12 via a direct pivot 13, via a linkage system with hydraulic cylinder 16 forming one member in the linkage system, or in any other appropriate manner. Implement 14 may be configured to pivot, rotate, slide, swing, or move relative to frame 12 in any other manner known in the art.

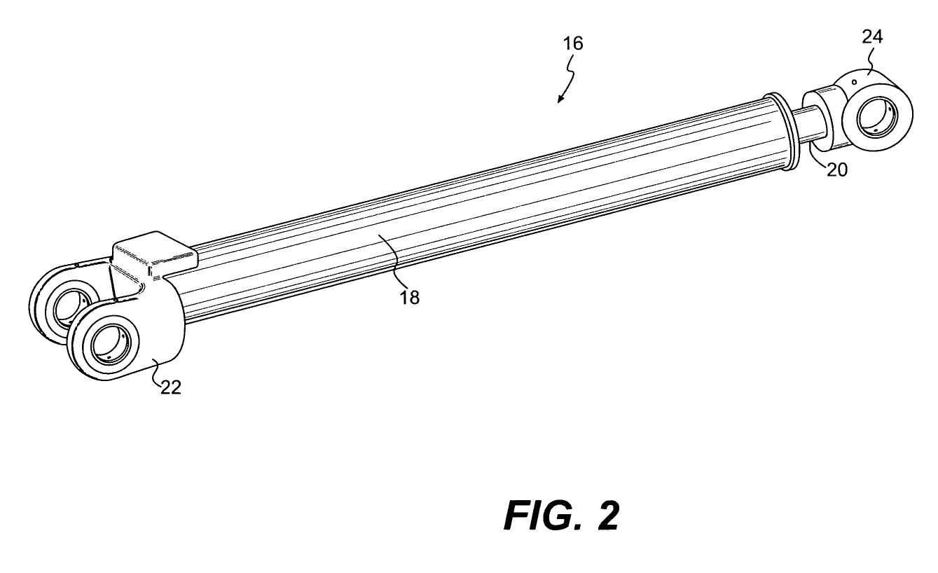

As illustrated in FIG. 2, hydraulic cylinder 16 may include a tube 18, a piston assembly 20 slidably disposed within tube 18, a cap assembly 22 operably connected to tube 18, and an eye member 24 fixedly connected to piston assembly 20. One of eye member 24 and cap assembly 22 may be pivotally connected to frame 12, while the other of eye member 24 and cap assembly 22 may be pivotally connected to implement 14. It is contemplated that eye member 24 and/or cap assembly 22 may alternatively be fixedly connected to either frame 12 or implement 14. Hydraulic cylinder 16 may be supplied with a pressurized fluid to cause piston assembly 20 to displace within tube 18 to expand hydraulic cylinder 16. Hydraulic cylinder 16 may also be connected to a fluid drain to cause piston assembly 20 to displace within tube 18 to retract hydraulic cylinder 16. The expansion and retraction of hydraulic cylinder 16 may function to assist in moving implement 14 (referring to FIG. 1).

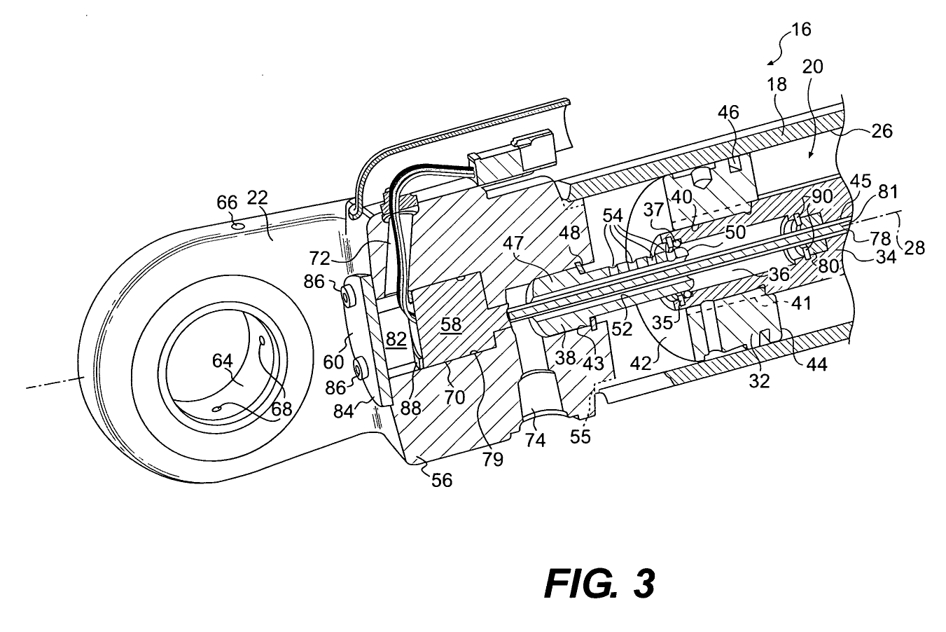

FIG. 3 illustrates tube 18 of hydraulic cylinder 16 as having a generally cylindrical internal cavity 26. It is also contemplated that tube 18 may have a different internal shape, such as, for example, a square cross-section, a rectangular cross-section, a triangular cross-section, or any other shape known in the art. Internal cavity 26 may have a centralized longitudinal axis 28 extending therethrough.

Piston assembly 20 may include a first end axially aligned with and disposed within tube 18, and a second end connected to eye member 24 (referring to FIG. 2). Piston assembly 20 may include a piston 32 located towards the first end, and a piston rod 34 extending toward the second end. Piston 32 may be a generally cylindrical member having an axial bore 40 with internal threads 41. Piston 32 may include a first hydraulic surface 42 and a second hydraulic surface 44 opposite first hydraulic surface 42. An imbalance of force caused by fluid pressure on first and second hydraulic surfaces 42, 44 may cause piston assembly 20 to move within tube 18 along longitudinal axis 28. For example, a force resulting from fluid pressure acting on first hydraulic surface 42 being greater than a force resulting from fluid pressure acting on second hydraulic surface 44 may cause piston assembly 20 to displace, expanding hydraulic cylinder 16. Similarly, when a force on second hydraulic surface 44 is greater than a force on first hydraulic surface 42, piston assembly 20 may retract within tube 18 contracting hydraulic cylinder 16. Piston 32 may include an annular groove 46 disposed within an outer cylindrical surface between the first and second hydraulic surfaces 42, 44. A sealing member (not shown), such as an o-ring, may be disposed within groove 46 to restrict a flow of fluid between the wall of internal cavity 26 and the outer cylindrical surface of piston 32.

Piston rod 34 may be removably connected to piston 32. For example, piston rod 34 may include external threads configured to engage internal threads of piston 32. Alternatively, piston 32 may include a through hole configured to slidably receive piston rod 34, and one or more fasteners (not shown) configured to engage piston rod 34 and secure piston 32 to piston rod 34. It is contemplated that piston 32 may alternatively be fixedly connected to piston rod 34 such as, for example, by welding. It is further contemplated that piston 32 and piston rod 34 may be a single integral part, if desired. Piston rod 34 may include an axial bore 45 extending the length of piston rod 34, and a stepped bore 36 disposed at the first end near piston 32. Additionally, piston rod 34 may include a snap-ring 35 disposed within an internal groove or piston rod 34, and configured to retain a floating collar 37. Specifically, floating collar 37 may be slidably disposed between a shoulder of stepped bore 36 and snap-ring 35.

Cap assembly 22 may be removably connected to tube 18. For example, cap assembly 22 may include external threads 55 configured to engage internal threads of tube 18. Cap assembly 22 may alternatively include internal threads configured to engage external threads of tube 18, may be connected to tube 18 via one or more fasteners, or may be connected to tube 18 in any other manner known in the art. Cap assembly 22 may include a body 56, a sensor 58 disposed within body 56, and a valve plunger 38 connected to body 56 and configured to slidably move within stepped bore 36 of piston rod 34.

Body 56 may include one or more bushings 64 configured to slidably and/or pivotally engage either frame 12 or implement 14. One or more fluid passageways (not shown) may connect a lubrication inlet port 66 to one or more lubrication outlet ports 68 within bushings 64. A lubricating fluid (not shown) may be provided to the body fluid passageways via inlet port 66 such that a lubricating film exists between bushing 64 and an engagement member (not shown) of either frame 12 or implement 14 during operation of hydraulic cylinder 16. Body 56 may also include a central bore 70 configured to receive sensor 58, a passageway 72 configured to house a wire harness portion of sensor 58, and a fluid port 74. Additionally, body 56 may include a counter bore 43 in fluid communication with fluid port 74 and configured to receive valve plunger 38.

Sensor 58 may be disposed within central bore 70 and may include a sealing member (not shown) disposed within a groove 79 to restrict fluid flow between central bore 70 and sensor 58. Sensor 58 may be a magnetostrictive-type sensor that includes a pressure pipe 78 extending axially into and through an axial bore 52 of valve plunger 38 and into at least a portion of axial bore 45 of piston rod 34. Pressure pipe 78 may contain a magnetostrictive element or wave guide 81 that interacts with an annular magnet 80 mounted in axial bore 45 of piston rod 34. Annular magnet 80 may be held within stepped bore 36 by way of a snap-ring 90.

Wave guide 81 may include a wire (not shown) connected to sensor 58 and extending through pressure pipe 78. Sensor 58 may be operable to generate current pulses, which are sent through the wire. Annular magnet 80 may extend annularly around pressure pipe 78 to produce a magnetic field, which interacts with the current pulse causing a torsional pulse in the wave guide. The torsional pulse is transmitted as a torsional strain wave that has a specific time period and is reflected back to sensor 58. The time period may be compared to the time of launch of the current pulse to determine the distance to annular magnet 80 from sensor 58. This distance may correspond with the effective length of hydraulic cylinder 16.

Cap member 60 may include one or more protrusions 82 extending from a plate member 84. Protrusions 82 may be configured to position sensor 58 within body 56 as plate member 84 is assembled to body 56 by one or more fasteners 86. Protrusions 82 may be separated from position sensor 58 by a resilient member 88 configured to protect sensor 58 from compressive forces during torquing of fasteners 86.

Floating collar 37 may be configured to move between the shoulder of stepped bore 36 and snap-ring 35 along longitudinal axis 28. Specifically, the movement of floating collar 37 along longitudinal axis 28 may inhibit snubbing during expansion and facilitate snubbing during retraction of hydraulic cylinder 16. Floating collar 37 may have a smaller internal diameter than stepped bore 36 to inhibit valve plunger 38 from contacting the inner walls of stepped bore 36.

Valve plunger 38 may include a first end 47 disposed within counter bore 43 of body 56 and fixedly retained therein by a snap-ring 48. Specifically, snap-ring 48 may be disposed within an internal groove of counter bore 43 and configured to press against a shoulder of valve plunger 38. Alternatively, first end 47 of valve plunger 38 may be welded to cap assembly 22, may include external threads configured to engage internal threads within counter bore 43 of cap assembly 22, or may be fixedly connected to cap assembly 22 in any other manner known in the art. Axial bore 52 may extend from first end 47 through a second end 50 and align with axial bore 45 of piston rod 34. Axial bore 52 may accommodate the passage of pressure pipe 78 and a flow of fluid into or out of internal cavity 26.

Valve plunger 38 may also include a plurality of snubbing passages 54 extending radially from an axial bore 52 through an annular wall of valve plunger 38. Specifically, snubbing passages 54 may fluidly connect axial bore 52 to internal cavity 26 of hydraulic cylinder 16 to allow a multi-stage snubbing action, as first hydraulic surfaces 42 nears cap assembly 22. That is, as stepped bore 36 moves over valve plunger 38, floating collar 37 may progressively block snubbing passages 54, thereby restricting the fluid flow between cap assembly 22 and piston 32. It is contemplated that floating collar 37 may be omitted and the internal walls of stepped bore 36 may, alternatively, be used to block snubbing passages 54, if desired. Snubbing passages 54 may be disposed in an inline configuration (shown in FIG. 3), a staggered configuration, and/or any other configuration as needed or desired for design and/or operation of hydraulic cylinder 16. Additionally, the sizing and/or shape of snubbing passages 54 may be configured to provide discrete stages of snubbing (i.e. step increases in the rate of restriction applied to the fluid flow from internal cavity 26 via valve plunger 38 and fluid port 74).

### INDUSTRIAL APPLICABILITY

The disclosed hydraulic cylinder may be applicable to any apparatus where mechanical impact protection between a piston within the hydraulic cylinder and an end structure of the hydraulic cylinder is undesired. In the disclosed embodiment, a valve plunger may provide a multi-stage snubbing for mechanically cushioning the impact between the piston assembly and an end of the hydraulic cylinder. The disclosed hydraulic cylinder may be used in conjunction with mechanically, hydraulically, or electronically actuated valves that control fluid flow to or from the hydraulic cylinder. In fact, a sensor internally disposed within the hydraulic cylinder may determine a position of the piston relative to the end structure for use in controlling the valves. The multi-stage snubbing may be used as a primary means to cushion the end of a piston stroke or may be used as a backup system that is secondary to the position-based valve controlled system using input from the sensor. Additionally, the location of the valve plunger within the end structure may increase the reliability and/or durability of the hydraulic cylinder. The operation of hydraulic cylinder 16 will now be explained.

Fluid may be introduced into tube 18 at first hydraulic surface 42, while draining fluid away from second hydraulic surface 44 to create a pressure differential across piston 32. The pressure differential may cause piston assembly 20 to move away from cap assembly 22, thereby expanding hydraulic cylinder 16. Fluid may also be drained from first hydraulic surface 42, while directing pressurized fluid to second hydraulic surface 44 of piston 32. As fluid is drained from first hydraulic surface 42, piston assembly 20 may retract within tube 18 to retract hydraulic cylinder 16. Fluid may be introduced to and drained from first hydraulic surface 42 through fluid port 74. Specifically, fluid may pass through and end of axial bore 52 and into axial bore 52 via snubbing passages 54 of valve plunger 38 as fluid is introduced into and drained from first hydraulic surface 42.

To inhibit piston assembly 20 from impacting cap assembly 22 during retraction, fluid flow out of tube 18 through axial bore 52 may be restricted or the movement of piston assembly 20 may be snubbed by valve plunger 38. Specifically, as stepped bore 36 of piston rod 34 moves over snubbing passages 54 during movement of piston assembly 20 towards cap assembly 22, the area available for fluid flow into axial bore 52 and out of tube 18 may be reduced in discrete stages. Each stage may correspond to the sequential sealing of at least one snubbing passage 54. This reduction in available flow area may help to create a buildup in pressure between piston assembly 20 and cap assembly 22 that slows and eventually stops movement of piston assembly 20 relative to cap assembly 22 in a multi-stage manner. In this way, impact between piston assembly 20 and cap assembly 22 may be inhibited. It is contemplated that an arrangement (not shown) similar to valve plunger 38 and cap assembly 22 may be located towards the second end of hydraulic cylinder 16 having eye member 24 to similarly cushion the end of an expansion stroke of piston assembly 20 within cylinder 16.

Hydraulic cylinder 16, disclosed herein, may benefit from the snubbing action at the end of a piston stroke. The restriction of fluid flow by via snubbing passages 54 in a discrete multi-stage manner may also provide a more desired snubbing of hydraulic cylinder 16. Additionally, because valve plunger 38 may be located within cap assembly 22 it may move and vibrate little during the operation of hydraulic cylinder 16. That is, the stationary location of valve plunger 38 may substantially isolate valve plunger 38 from the movement and vibration associated with piston assembly 20. This substantial isolation may result in low wear and improved life for valve plunger 38. Sensor 58 may be beneficial in determining the effective length of hydraulic cylinder 16 and, if desired, the regulation an electronically-controlled hydraulic valve system. Because valve plunger 38 accommodates sensor 58, either system may be utilized.

It will be apparent to those skilled in the art that various modifications and variations can be made to the disclosed hydraulic cylinder. Other embodiments will be apparent to those skilled in the art from consideration of the specification and practice of the disclosed hydraulic cylinder. It is intended that the specification and examples be considered as exemplary only, with a true scope being indicated by the following claims and their equivalents.

What is claimed is:

1. A hydraulic cylinder, comprising:
a tube having a first end and a second end;
a cap assembly connected to the first end of the tube to close off the first end of the tube;
a piston assembly having a piston rod, and being movably disposed within the tube to move between the first end and the second end of the tube; and
a valve plunger connected to the cap assembly and having a first axial bore and a plurality of radially oriented passages configured to sequentially restrict fluid flow through the first axial bore as the piston assembly approaches the first end of the tube.

2. The hydraulic cylinder of claim 1, further including a stepped bore disposed at the piston end of the piston rod and being configured to receive the valve plunger during movement of the piston assembly.

3. The hydraulic cylinder of claim 2, wherein internal walls of the stepped bore sequentially restrict fluid flow through the plurality of radially oriented passages as the stepped bore moves over the valve plunger.

4. The hydraulic cylinder of claim 2, further including a floating collar disposed within the stepped bore, and configured to sequentially restrict fluid flow through the plurality of radially oriented passages as the valve plunger slides through the floating collar during retraction of the hydraulic cylinder.

5. The hydraulic cylinder of claim 1, wherein the plurality of radially oriented passages extend from the first axial bore radially outward through a wall of the valve plunger.

6. The hydraulic cylinder of claim 1, further including a port in fluid communication with the first axial bore to pass fluid into and drain fluid out of the hydraulic cylinder.

7. The hydraulic cylinder of claim 1, wherein the piston rod includes a second axial bore extending at least a portion of the length of the piston rod and being aligned with the first axial bore within the valve plunger.

8. The hydraulic cylinder of claim 7, wherein the cap assembly further includes:
a central bore axially aligned with the tube; and
a sensor disposed within the central bore.

9. The hydraulic cylinder of claim 8, further including one or more protrusion configured to retain and position a portion of the sensor within the cap bore.

10. The hydraulic cylinder of claim 9, further including a sensor member disposed within the second axial bore of the piston rod and the first axial bore of the valve plunger.

11. The hydraulic cylinder of claim 10, further including a magnet coupled to the piston assembly and configured to interact with the sensor.

12. A method of operating a hydraulic cylinder, comprising:
filling and draining fluid from both a first end and second end of the hydraulic cylinder;
creating a force differential within the hydraulic cylinder to expand and retract the hydraulic cylinder; and
restricting a flow of fluid at a plurality of locations in a discrete multi-stage manner, wherein the plurality of locations always remain at the first end of the hydraulic cylinder.

13. The method of claim 12, wherein restricting a flow of fluid includes restricting the flow at the end of the retracting operation.

14. The method of claim 12, wherein restricting a flow of fluid in a multi-stage manner includes sequentially blocking fluid flow at each of the plurality of locations.

15. The method of claim 12, wherein restricting a flow of fluid at a plurality of locations creates a pressure at the first end that increases in a step-wise manner as each of the plurality of locations is blocked.

16. The method of claim 15, further including measuring an effective length of the hydraulic cylinder from inside the hydraulic cylinder.

17. The method of claim 16, wherein measuring the effective length includes measuring a time period of a torsional strain wave and comparing the time period to a time of initiation from the first end.

18. A machine, comprising:
a frame;
an implement; and
a hydraulic cylinder operatively connected to the frame and configured to assist in moving the implement, the hydraulic cylinder including:
a tube having a first end and a second end;
a cap assembly connected to the first end of the tube to close off the first end of the tube;
a piston assembly having a piston rod, and being movably disposed within the tube to move between the first end and the second end of the tube; and
a valve plunger connected to the cap assembly and having a first axial bore and a plurality of radially oriented passages configured to sequentially restrict fluid flow through the first axial bore as the piston assembly approaches the first end of the tube to slow the movement of the implement.

19. The machine of claim 18, further including a stepped bore disposed at the piston end of the piston rod and being configured to receive the valve plunger during movement of the piston assembly; wherein internal walls of the stepped bore sequentially restrict fluid flow through the plurality of radially oriented passages as the stepped bore moves over the valve plunger.

20. The machine of claim 18, further including a floating collar disposed within the piston rod, and configured to sequentially restrict fluid flow through the plurality of radially oriented passages as the valve plunger slides through the floating collar during retraction of the hydraulic cylinder.
